(19) United States
(12) Patent Application Publication
(10) Pub. No.: US 2009/0278399 A1
(43) Pub. Date: Nov. 12, 2009

(54) Wheels of unitary construction and method of making same

(76) Inventors: Ram Srivats, Chennai (IN); S. Jayaram, Chennai (IN)

Correspondence Address: REED SMITH LLP, 2500 ONE LIBERTY PLACE, 1650 MARKET STREET, PHILADELPHIA, PA, 19103, US

(21) Appl. No.: 10/585,389

(22) PCT Filed: Jan. 6, 2005
(86) PCT No.: PCT/IN05/00006

§ 371 Date: Oct. 14, 2008

(30) Foreign Application Priority Data
Jan. 7, 2004 (IN) 012/CHE/04

(51) Int. Cl. B60B 21/00; B21D 53/26; B21D 22/18

(52) U.S. Cl. 301/95.101; 29/894.324; 29/802; 72/83

(57) ABSTRACT

This invention relates to a unitary steel wheel as well as an apparatus and method for producing a unitary steel wheel. The unitary wheel comprises rim and disc components. In one embodiment, the unitary wheel further comprises approximately a 50 taper bead-seat for flat or semi-drop cantar rims, produced from a generally circular steel blank. The blank preferably has a cantar hole of predetermined size. In a first step, the blank is initially placed in a spinning machina to form disk and rim portions of a predetermined profila and shape. The preform is further spun and flow formed in the spinning machine, to form a gutter, well, bead-Seat, and/or fixed flange. The preform is then forward and reverse spun to form the final profila and shape of the gutter, wall, bead-seat, and/or fixed flange.

### FIELD OF INVENTION

This invention generally relates to wheels and particularly to wheels used with vehicles. In particular this invention relates to steel wheels and, more particularly, to steel wheels having approximately 5° taper bead-seats in flat or semi-drop center rims. Such wheels may be used with any type of vehicle, including but not limited to commercial vehicles. This invention further relates to a method of manufacturing the wheel of this invention.

### BACKGROUND OF THE INVENTION

Specifications for wheels having approximately 5° taper and profile (where tire contact is involved) bead seats are generally set forth in international tire and rim standards, manuals, and handbooks such as ETRTO, T&RA, and JATMA. These specifications are generally applicable for all types of 5° bead seat rims such as semi-drop center, flat base, as well as other types of wheels. Wheels of this configuration typically accommodate tires having inner tubes. Such wheels may also be used with tubeless type tires where a suitable seal is created between the tire and wheel (as recommended by tire manufacturer). In addition, suitable removable flange/flanges (as recommended by wheel manufacturer) at the end/ends of the rim may also be incorporated into such wheels.

Typically, a fabricated sheet steel wheel having a 5° taper bead-seat of flat-base or semi-drop center rims for a vehicle are fabricated from more than one component. For example, the inner periphery of a separate rim component may be welded or otherwise affixed to a separate central disc component also made of sheet steel. The tire mounts on the outer periphery of the rim supported by the central disc provides a means for attaching to spindle hubs the brake drum or other associated parts of the vehicle. With such wheel construction it is important that the rim and disc, in their assembled relationship, insure (within acceptable tolerances) roundness of the rim and accurate axial alignment of the rim with respect to the disc. Deviations in the roundness of the rim and axial alignment are referred to as “radial” and “axial” run-outs, respectively. In this regard, vehicle manufacturers establish extremely rigid tolerances and run out specifications.

When wheels are manufactured by conventional methods, the rim and discs are normally manufactured as separate components. These two components are then assembled together in a press or in a fixture. The disc is fixed at its outer peripheral flange to the inner periphery of the rim by welding (or other appropriate method) to form the complete wheel assembly. When utilizing the conventional method of making the rims by using a butt-welded hoop made out of a strip of hot rolled steel sections or plate, maintaining acceptable tolerances on the roundness of the rim hoop is extremely difficult due to the localized “kink” in the region of the butt welded joint and the non-uniform spring back during the rim diameter calibration operation. Likewise, maintaining accurate dimensional control in making the disc is also difficult because of cold press forming inconsistencies brought about by variations in the disc dimensions and other properties of the disc base material stock. Furthermore, substantial distortion encountered during the welding of the disc and rim requires costly additional corrective steps in the manufacturing process to ensure that the axial alignment is held within acceptable limits. Once such distortion has occurred, it generally cannot be completely corrected. In addition, the welded assembly does not readily lend itself well to rigorous balancing and centering of the conventional wheel configuration. A shift in the axial alignment and the localized kink in the rim in the region of the butt welded joint is known to produce first harmonics while the vehicle is running, thus causing vibration and high noise. The axial shift between the disc and the rim also produces imbalance of the wheel causing vehicle disturbance, thumping, vibration and shaking.

Further, when conventional wheels have been run with test overloads to induce failure, fatigue and cracks have often occurred in the center of the disc where the disc is attached to its supporting axle, and in the welds which attach the rim to the disc.

Another problem encountered with the conventional wheel design is the limitation in the size of the break drum used with the conventional wheel. This limitation is due to the disc peripheral portion being assembled under the rim, thus restricting the space available for accommodating a break drum of larger size. Today's vehicle carries more load at higher speeds. From the safety perspective, it is desirable to provide a greater area in the wheel to accommodate breaking components for improved breaking performance.

In addition, it is well recognized that wheels are not only critical to safety in the use of an automotive vehicle, but also being an un-sprung mass has a pronounced effect on vehicle stability and driving comfort.

However, to date, conventional wheel constructions and methods of assembly have not addressed the foregoing issues. Thus, a unitary (also referred herein as “one-piece”) wheel construction which comprises rim and disc portions formed from the substantially contiguous single or unitary piece of substrate material, such as steel, and method for making such a wheel would address the deficiencies found in the conventional wheel construction described above. Additionally, a unitary wheel rim and disc assembly comprising low carbon and high strength steel would lead to a reduction in weight and would facilitate balancing and centering of the wheel. Thus, a unitary wheel rim and disc assembly, and particularly a wheel assembly comprising a 5° taper bead-seat of flat or semi-drop center rims, would provide improved technical and economic benefits inasmuch as the unitary construction lends itself to cost effective mass production, improved strength, consistency in dimensions and vibration within established tolerances, as well as other improved characteristics.

This application claims the priority of both Indian Patent Application No. 012/CHE/04, entitled A METHOD OF MANUFACTURING INTEGRAL WHEEL RIM AND DISC ASSEMBLY OF A 5° TAPER BEAD-SEAT OF FLAT OR SEMI-DROP CENTER RIM AND INTEGRAL WHEEL CONSTRUCTION, filed on Jan. 7, 2004, and Indian Patent Application No. 013/CHE/04, entitled A METHOD OF MANUFACTURING ONE-PIECE WHEEL OF A 5° & 15° DROP CENTER RIMS AND THE ONE-PIECE WHEEL CONSTRUCTION, filed on Jan. 7, 2004, the entire disclosures of which are hereby incorporated by reference as if being set forth in their respective entireties herein.

### SUMMARY OF THE INVENTION

The present invention relates to a steel wheel of substantially unitary construction. The wheel comprises a disc portion and a rim portion substantially contiguous with said disc portion, wherein the wheel is of substantially unitary construction. The invention also relates to an apparatus and method for producing unitary steel wheels. More specifically, the invention relates to a method of manufacturing a steel wheel comprising the steps of forming a disc portion, and forming a rim portion, wherein said rim portion is substantially contiguous with said disc portion and wherein said wheel is of substantially unitary construction.

In one embodiment of the invention, the unitary steel wheel of this invention further comprises a wheel having approximately a 50 taper bead-seat of flat base or semi-drop center rim. This construction lends itself particularly well to mass production and provides wheels which meet the requirements enumerated above. A unitary wheel rim and disc assembly, and particularly an assembly which includes a 5° taper bead seat of flat or semi drop center rims, requires less material to construct and is substantially simpler to fabricate as there are no parts to assemble and no welding or other steps required to align or affix separate components. However, in some embodiments of this invention, it may be desirable to incorporate some assembled components requiring alignment or affixation. Regardless of the embodiment constructed, however, cost savings are realized with the method for making the wheel of the invention hereof.

Turning now to an embodiment of the invention which comprises a unitary wheel comprising a rim and disc assembly having a 5° taper bead-seat of flat or semi-drop center rim, the wheel construction consists of a substantially contiguous and typically substantially circular blank formed from steel sheet stock of pre-determined and substantially uniform thickness. The blank preferably has a center hole of predetermined size formed therein or otherwise pierced therethrough. The blank is preformed in a spinning machine to a predetermined profile and cylindrical shape. The performed blank is further spun and flow formed in the spinning machine, wherein the preform is positioned between an outer roller and inner mandrel and held against a clamping plate. The inner mandrel comprises an outboard surface, which conforms to the predetermined inner diameter of the rim, wherein the rim comprises a gutter portion, a well, a tire bead-seat and fixed flange. The outer roller comprises an outboard surface, which conforms to the final shape and profile of the gutter wall. The preform's peripheral cylindrical portion is then spun against the outboard surface of the inner mandrel and outboard surface of the outer roller to displace the material in backward and forward directions to form the final profile and shape of the gutter wall and predetermined profile and form of the well, bead-seat, and fixed flange respectively. The spun rim comprising the gutter, well and bead seat is further spun and flow formed in a spinning machine, while being positioned between an outer mandrel and an inner clamping plate. The outer mandrel comprises an inboard surface which conforms to the final shape of the fixed flange and 5° angle of the bead-seat which is spun and flow formed against the inner surface of the outer mandrel by a shaping roller of predetermined shape to form the final shape of the fixed flange and 5° bead-seat.

One aspect of the present invention is a unique cold forward and reverse spinning and flow forming method for manufacturing unitary steel wheel rim and disc assemblies for vehicles, and particularly for wheels having a 5° taper bead-seat of flat-base or semi-drop center construction. Generally, a circular steel blank formed from sheet stock of pre-determined uniform thickness is provided. The blank preferably has a center hole of a predetermined size is preferably formed or punched therethrough. The blank is placed in a spinning machine and preformed to a predetermined profile and shape. The perform is further spun and flow formed in the spinning machine while the preform is positioned between an outer roller and inner mandrel while being held against a clamping plate. The inner mandrel comprises an outboard surface, which conforms to the predetermined inner diameter of the rim. The rim portion comprises a gutter portion, well, a bead-seat and fixed flange. The outer roller comprises an outboard surface which conforms to the final shape and profile of the gutter wall. The peripheral portion of the preform is then forward and reverse spun against the outboard surface of the inner mandrel and outboard surface of the outer ring to form a predetermined profile and form of the well, bead-seat, fixed flange and the final profile and shape of the gutter wall respectively. The spun rim comprising the gutter, well and bead seat is further spun and flow formed in a spinning machine, while positioned between an outer mandrel and an inner clamping plate. The outer mandrel comprises an inboard surface, which conforms to the final shape of the fixed flange and 5° bead-seat. The preform is then spun and flow formed against the inner surface of the outer mandrel by a shaping roller of predetermined shape to form the final shape of the fixed flange and 5° bead-seat.

In another embodiment of the invention, the preform may be subjected to such operations where the center hole, mounting holes and the vent holes are pierced or otherwise formed in the wheel to a predetermined size, preferably before backward and forward spinning of the preform.

After the final rim profiling and shaping operation, the center hole, vent hole, and/or the mounting holes may be machined to predetermined dimensions in a multi drilling machine or by other suitable means.

Thus, the present invention provides a unique, low cost method of press forming, spinning and flow forming a unitary wheel rim and disc assembly and particularly a wheel having a 5° taper bead-seat of flat or semi-drop center rims. The steel blank is formed from sheet stock and is spun and flow formed in a spinning operation which reduces manufacturing costs over conventional methods. The spinning and flow forming technique of this invention employs tools having simple forming surfaces, which minimizes their associated manufacturing cost, as well as repair expenses. The spin forming machine can be easily programmed to form different shapes, such that the present method is especially suited for making specialty and/or low volume wheel designs as well as one-piece type vehicle wheels for bulk manufacturing.

These and other advantages of the invention will be further understood and appreciated by those skilled in the art by reference to this written specification, as well as the claims and appended drawings.

### BRIEF DESCRIPTION OF THE DRAWINGS

The invention will become more readily apparent from the following description of the preferred embodiments therein shown by way of example only, in the accompanying drawings where like numerals designate corresponding parts and features in the various views wherein:

FIG. 1—shows a sectional schematic view of a steel disc blank having a center hole used in constructing the disc component of a welded wheel having a 5° taper bead-seat in a flat-base or semi-drop center rim of the prior art.

FIG. 2—shows sectional schematic view of the steel disc component used in constructing a welded wheel having a 5° taper bead-seat in a flat base or semi-drop center rim of the prior art.

FIG. 3—shows sectional schematic view of a finished disc component with mounting, central and vent holes used in constructing a welded wheel having a 5° taper bead-seat in a flat base or semi-drop center rim of the prior art.

FIG. 4—shows a sectional schematic representation of the welded hoop formed from flat plate used in constructing the steel rim component for a welded wheel having a 5° taper bead-seat in a flat base or semi-drop center rim of the prior art.

FIG. 5—shows a sectional schematic representation of the welded hoop after milling, which hoop is used in constructing the steel rim component for a welded wheel having a 5° taper bead-seat in a flat base or semi-drop center rim of the prior art.

FIG. 6—shows a sectional schematic representation the rolling process used in constructing the steel rim component for a welded wheel having a 5° taper bead-seat in a flat base or semi-drop center rim of the prior art.

FIG. 7—shows a sectional schematic representation of the calibration operation used in constructing the steel rim component for a welded wheel having a 5° taper bead-seat in a flat base or semi-drop center rim of the prior art.

FIG. 8—shows a sectional schematic representation of the completed assembly of the prior art wheel having a 5° taper bead-seat in a flat base or semi-drop center rim after the disc and rim components are welded together.

FIG. 9—shows a sectional view of a steel disc blank having a center hole used in constructing wheels of unitary construction having a 5° taper bead-seat in a flat or semi-drop center rim in accordance with the present invention.

FIG. 10—shows a schematic sectional representation of the first stage of spinning process used in forming the disc and rim portions of a wheel of unitary construction having a 5° taper bead-seat in a flat or semi-drop center rim, in accordance with the present invention.

FIG. 11—shows a schematic sectional representation of the spun wheel from the FIG. 10, wherein mounting and center holes have been formed in accordance with the present invention.

FIG. 12—shows a schematic sectional representation of the spun wheel from FIG. 11, wherein vent holes have been formed in accordance with the present invention.

FIG. 13—shows a schematic sectional representation of the second stage of the forward and backward displacement of material during the spinning process which continues the process of forming the disc and rim portions of wheels of unitary construction having a 5° taper bead-seat in a flat or semi-drop center rim in accordance with the present invention.

FIG. 14—shows a schematic sectional representation of the final stage of spinning processes which substantially forms the final profile and shape of the well, bead-seat and fixed flange in a wheel of unitary construction having a 5° taper bead-seat in a flat or semi-drop center rim in accordance with the present invention.

FIG. 15—shows a schematic sectional representation of the process for providing machine finished surfaces to the fixed flange edges of FIG. 14, in accordance with the present invention.

FIG. 16—shows perspective and sectional views of the steel wheel of unitary construction having a 5° taper bead-seat in a flat or semi-drop center rim in accordance with the present invention, the perspective view showing a section removed to view the cross-sectional profile.

### DETAILED DESCRIPTION OF THE INVENTION

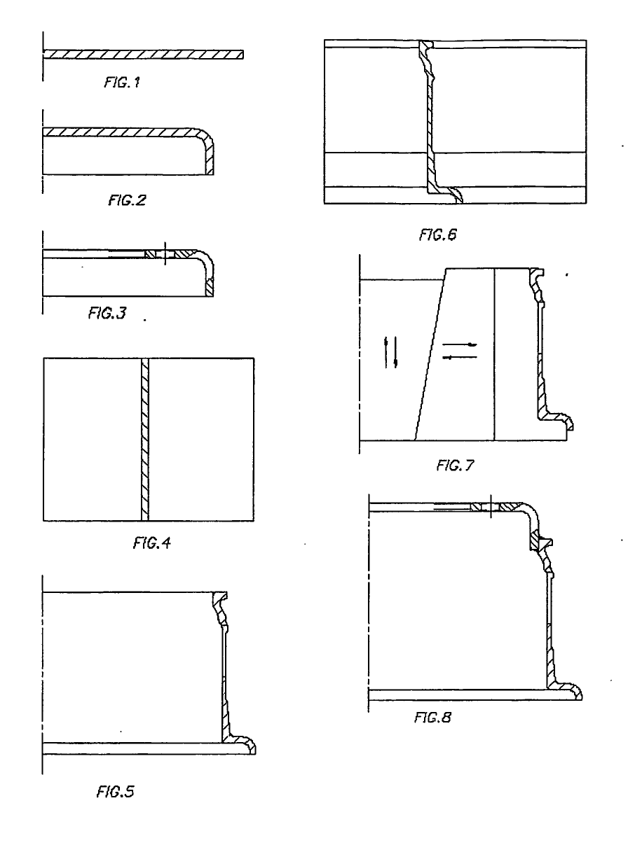

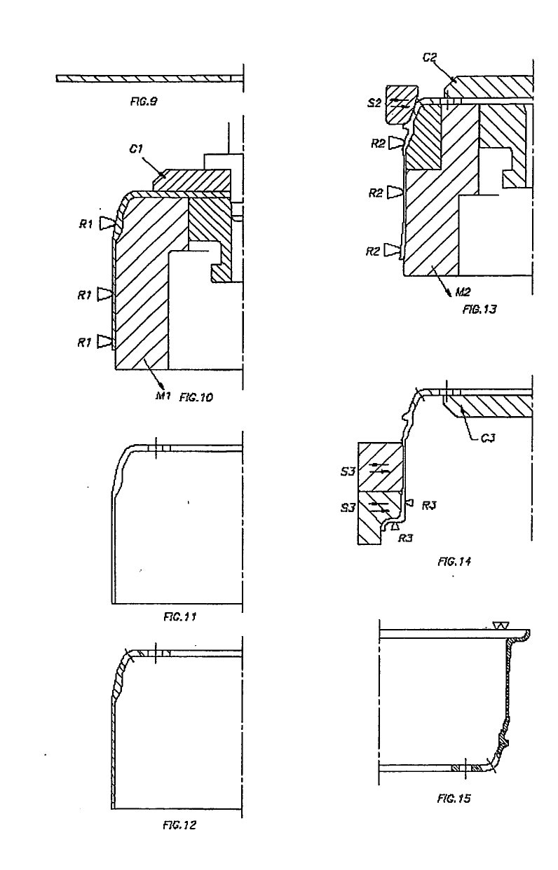

Turning now to FIGS. 1 through 8, the conventional method of manufacturing a steel wheel having a 5° taper bead-seat in a flat or semi-drop center rim is shown. The method requires that the rim and disc are manufactured as separate components and then joined together by conventional means such as welding.

The initial steps involved in the manufacture of a conventional steel wheel comprises forming circular blank of pre-determined thickness, press-forming and piercing the center hole, and particularly the mounting and vent holes as, shown for example in FIG. 1, FIG. 2 and FIG. 3.

The rim is manufactured either by using a flat plate of uniform thickness or using the profiled hot rolled plate as shown in FIG. 4 and FIG. 5. In either case the plate is coiled into a hoop, butt-welded, joint trimmed and dressed. In the case of a flat plate, the profile of the rim is achieved using either hot or cold press or spinning operations. Finally, the rims are roll formed and calibrated for the diameter and out-of roundness (run-out) accuracy as shown in the FIG. 6 and FIG. 7.

The finished discs and rims are then assembled in a press or a fixture and the joints are welded or joined by other means after assembly as shown in FIG. 8. The wheels subsequently undergo machining steps to machine and finish the center valve slot and center, vent and mounting holes.

In contrast to the wheel construction shown in FIGS. 1 through 8, the invention disclosed herein relates to a unitary wheel made of metal, such as steel (such as low carbon steel of HSLA steel composition) or other suitable substrate, as well as the apparatus and method of producing a unitary wheel. The unitary wheel comprises both rim and disc portions. The unitary wheel is constructed from a generally circular steel blank formed from sheet stock of pre-determined, substantially uniform thickness. In addition, the blank preferably has a center hole having a predetermined size. In one embodiment, the rim component further comprises a flat or semi-drop center rim having approximately a 5° taper bead-seat. In an initial fabrication step, the blank is preformed in a spinning machine to a predetermined profile and shape. In a subsequent step, the preform is further spun and flow formed in a spinning machine, the preform being positioned between an outer roll and inner mandrel and held against a clamping plate. The inner mandrel comprises an outboard surface which conforms to the predetermined inner diameter of the rim comprising, for example, a gutter portion, well, bead-seat and fixed flange. An outer roller comprises an outboard surface which conforms to the final shape and profile of, for example, the gutter wall. In yet further subsequent steps, the preform peripheral portion is then forward and reverse spun against the outboard surface of the inner mandrel and outboard surface of the outer roller to form the final profile and shape of the wheel such as the gutter wall, and predetermined profile and form of, for example, the well, bead-seat, and fixed flange respectively and/or other desired portions. Subsequent process steps, such as machining of particular portions or components, may then be carried out to complete the manufacturing process.

As we now turn to the embodiment of the invention set forth in FIGS. 9 through 16, it should be noted that the descriptions set forth herein are made for the purpose of illustrating the general principles of this invention and the embodiments specifically referred to herein are offered as non-limiting embodiments of the invention disclosed herein.

One embodiment of the unitary wheel of this invention, as well as an embodiment of the method of making the unitary wheel, is set forth in FIGS. 9 through 16. Turning now to FIG. 16, perspective and sectional views of the wheel of this embodiment are shown. The wheel is of one-piece or unitary construction and is formed from a single piece of substrate material, such as steel or other suitable material. The substrate is of substantially uniform thickness and is usually provided as a substantially round disc having a center hole therethrough and located approximately at the center of the disc. The wheel is formed from the substrate disc into the wheel shown, which wheel comprises a disc portion and a rim portion, which rim portion is substantially contiguous with the disc portion.

The wheel of FIG. 16 (with additional views shown in FIGS. 9 through 15) further comprises gutter 1 and flange 4, each portion of which are formed from the substrate disc and are positioned approximately at opposing ends of the rim portion as contiguous portions of the wheel. Moreover, gutter 1 is also positioned approximately in the area near where the disc and the rim portions of the wheel meet on the inner portion of the wheel assembly, while flange 4 is positioned approximately at the outer edge of the rim portion. The rim portion further comprises well 2 and tire bead seat 3, each portions of which are also formed from the substrate disc as contiguous elements of the rim portion. Gutter 1 is approximately positioned between the disc portion and well 2, while bead seat 3 is approximately positioned between flange 4 and well 2. In addition, the wheel of FIG. 10 further comprises center hole 5, mounting holes 6, vent holes 7, and valve slot or hole 8. Center hole 5 is positioned approximately in the center of the disc portion of the wheel. Vent holes 7 are approximately positioned near the outer edge of the disc portion and approximately between gutter 1 and mounting holes 6. Mounting holes 6 are approximately positioned between center hole 5 and vent holes 7. Finally, valve slot or hole 8 is positioned approximately in or near well 2.

A method of manufacturing the embodiment of the wheel set forth in FIG. 16, is shown in FIGS. 9 through 15. FIG. 9 shows a schematic sectional view of the steel disc substrate having a center hole therethrough prior to forming pursuant to the method of this invention. The blank may be of any size or thickness which permits the wheel to be shaped to the desired dimensions.

FIG. 10 shows the first step of manufacturing one-piece wheels having 5° taper bead-seat of flat base or semi-drop center steel wheels which comprise spinning and flow forming the steel disc substrate of FIG. 9. Preferably, the disc is spun and flow formed into a preformed shape in a CNC 4-axis spinning machine or similar device. More specifically, the preform is held between inner mandrel M1 and clamping plate C1. Shaping rollers R1 are mounted on a hydraulically actuated slide of the spinning machine which imparts a rolling pressure on the outer peripheral portion of the preform. The spinning and rolling pressure reduces the thickness of the disc and rim portions while forming the cylindrical shape and profile in the rim portion of the preform in accordance with predefined settings in the spinning machine. The outboard surface of inner mandrel M1 corresponds to the predetermined cylindrical shape and profile of the inner diameter of the rim portion. Furthermore, this step may comprise one or more passes of shaping rollers R1 to produce the desired shape and profile of the preform.

FIG. 11 shows a cross sectional view of central hole 5 and a mounting hole 6, while FIG. 12 shows a cross sectional view of central hole 5, a mounting hole 6, and a vent hole 7. In a subsequent step or steps schematically depicted in FIGS. 11 and 12, each of mounting holes 6 and vent holes 7 are formed into the preform by conventional methods such as by a press or other means.

FIG. 13 shows yet another subsequent step wherein the preform is subjected to forward and backward spinning to extend and further form the rim portion comprising gutter 1, well 2, tire bead seat 3 and flange 4 into a cylindrical shape of desired thickness, diameter and width. Also, during backward spinning the rim portion comprising gutter 1 is spun in such a way that the material is displaced in a backward direction, also to a predetermined thickness, diameter and width.

More specifically, FIG. 13 discloses a subsequent step wherein the preform of FIG. 12 is spun and flow formed in a CNC 4-axis spinning machine or similar device. The preform is positioned between inner mandrel M2 and outer shaping rollers R2, and is clamped prior to spinning by clamping plate C2. Shaping rollers R2 are mounted on a hydraulically actuated slide of the spinning machine which imparts a rolling pressure on the outer peripheral portion of the preform. The spinning and rolling pressure further reduces the thickness of the disc and rim portions while forming and extending the cylindrical shape and profile of the rim portion to a desired thickness, diameter and width in accordance with predefined settings in the spinning machine. The outboard surface of inner mandrel M2 corresponds to the predetermined cylindrical shape and profile of the inner diameter of the rim portion, while the surface of shaping mandrel S2 corresponds to a predetermined shape and profile of gutter 1. Shaping rollers R2 are used for both forward and backward spinning to further form the outer surfaces of the rim portion and gutter 1.

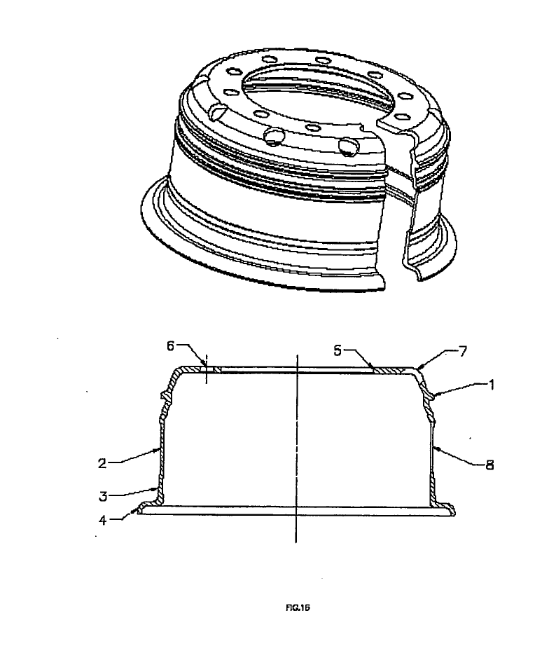

FIG. 14 shows yet another subsequent spinning and forming step which produces substantially the final profile of the disc and rim portions of the wheel. In this step, the preform of FIG. 13 is subjected to additional spinning and shaping to form substantially the final profile and shape of well 2, tire bead seat 3, and flange 4 of desired thickness, diameter and width.

More specifically, FIG. 14 discloses a subsequent spinning and forming step wherein the preform of FIG. 13, comprising gutter 1, well 2, 5° bead-seat 3, and fixed flange 4, is spun and formed in the spinning machine or similar device. Prior to spinning in this step, the preform is positioned between outer mandrels S3, shaping rollers R3 and an inner clamping plate C3. Outer mandrels S3 each comprise an inboard surface, which conforms to the final shape of fixed flange 4, and 5° bead-seat 3. Outer mandrels S3 are also located substantially adjacent to well 2, 5° bead-seat 3, and fixed flange 4. Shaping rollers R3 are mounted on the CNC spinning machine by a hydraulically actuated slide approximately opposed to outer mandrels S3. Once positioned, the preform is then further spun and flow formed in the spinning machine. Shaping rollers R3 impart a rolling pressure on the inner periphery of the rim portion of the preform which reduces the thickness and extends the cylindrical portion of the rim portion at desired points and substantially forms the final shape and profile of well 2, 5° bead seat 3, and fixed flange 4 to the desired thickness, diameter and width.

FIG. 15 shows a cross section of the profile of the final form and shape of the disc and rim portions after the final rim profiling and shaping operation. More specifically, center hole 5, vent holes 7, mounting holes 6, and/or valve slot or hole 8 may be machined to predetermined dimensions in a multi drilling machine or by other suitable means. In addition, fixed flange 4 may be machined to achieve a desired final shape, which step is preferably, but not necessarily performed after center hole 5, vent holes 7, mounting holes 6, and/or valve slot or hole 8 are machined.

Generally, the invention disclosed herein comprises a device, an apparatus, and a method of producing a unitary wheel which comprise the steps of providing a substantially circular steel blank and spinning the blank to of pre-determined uniform thickness and size. A center hole of predetermined size is preferably formed or pierced through the blank, substantially in the center of the blank. The blank is preformed in a spinning operation, and the perform is further forward and reverse spun in a spinning machine, being positioned between an inner mandrel, outer roll and a clamping plate. The inner mandrel has an outboard surface, which conforms to the cylindrical predetermined shape of the rim gutter, well, fixed flange. The outer roll has an outboard surface corresponding to the gutter profile. The spun perform inner peripheral portions is spin and flow formed against the surface of the inner mandrel to form the final shapes of the rim, bead seat, flange and/or other components of the wheel.

The method may further include the step of spin forming the peripheral portion of the blank by engaging the blank with a forming roller so as to obtain controlled thickness reduction and shape in the peripheral portion of the blank.

The method may further include the step of backward spinning a section of the blank peripheral portion against the shaping surface of an outwardly positioned roll to form the final shape of the rim gutter.

The method may further include the step of spin forming a section of the blank peripheral portion by engaging the same with a forming roller to form the final shape of the well base shape and dimension and at least a portion of the bead seat.

The method may further include the step of spin forming the bead seat portion of the blank inboard section against the shaping surface of the outer mandrel to form the final shape of fixed flange.

The method may further include the step wherein first-named spin forming step includes a plurality of passes of the forming roller.

The method may further include the step wherein after finish spinning operation bolt holes are pierced in a conventional press.

The method may further include the step wherein after piercing the bolt holes, vent holes are pierced in a conventional press

The method may also include the step of providing a disc blank of substantially uniform thickness and constructed from HSLA steel composition.

Throughout this detailed description, reference is made to the tools and dies that perform the various shaping operations. Any conventional means for carrying out the method of this invention may be employed including, but not limited to, the tooling used in the shaping operations including those known in the metal stamping/forming arts as well as those disclosed herein.

It is to be understood that the invention discussed herewith may assume various alternative embodiments and methods of manufacture. It is also to be understood that the specific devices and processes illustrated in the attached drawings, and described herein are merely exemplary embodiments of the inventive concepts defined by the appended claims. Hence, specific dimensions and other physical characteristics relating to the embodiments disclosed herein are not to be considered as limiting.

Further, since numerous modifications and changes will readily occur to those skilled in the art, it is not desired to limit the invention to the exact construction and operation shown and described, and accordingly all suitable modifications and equivalents may be regarded as falling within the scope of the invention as defined by the claims that follow.

What is claimed is:

1. A steel wheel comprising:
a disc portion; and
a rim portion substantially contiguous with said disc portion wherein said wheel is of substantially unitary construction.

2. The steel wheel of claim 1, further comprising a gutter portion which is substantially contiguous with said rim portion.

3. The steel wheel of claim 1, further comprising a well portion, which is substantially contiguous with, said rim portion.

4. The steel wheel of claim 1, further comprising a taper bead-seat portion, which is substantially contiguous with, said rim portion.

5. The steel wheel of claim 4, wherein said taper bead-seat has about a 5° taper.

6. The steel wheel of claim 5, wherein said wheel is of a flat base or semi-drop center type.

7. The steel wheel of claim 1, further comprising a flange portion, which is substantially contiguous with, said rim portion.

8. The steel wheel of claim 1, wherein said disc portion has a center opening therethrough.

9. The steel wheel of claim 1, wherein said disc portion has at least one mounting opening the therethrough.

10. The steel wheel of claim 1, wherein said disc portion has at least one vent opening therethrough.

11. The steel wheel of claim 1, wherein said disc portion has at least one valve opening therethrough.

12. The steel wheel of claim 1, substantially mounted to a vehicle.

13. The steel wheel of claim 1, further comprising a tire substantially mounted to said wheel.

14. A method of manufacturing a steel wheel comprising the steps of:
forming a disc portion; and
forming a rim portion wherein said rim portion is substantially contiguous with said disc portion and wherein said wheel is of substantially unitary construction.

15. The method of claim 14, wherein said wheel is formed from steel stock of substantially uniform thickness.

16. The method of claim 14, further comprising the step of forming a gutter portion, wherein said gutter portion is substantially contiguous with said rim portion.

17. The method of claim 14, further comprising the step of forming a well portion, wherein said well portion is substantially contiguous with said rim portion.

18. The method of claim 14, further comprising the step of forming a flange portion, wherein said flange portion is substantially contiguous with said rim portion.

19. The method of claim 14, further comprising the step of forming a taper bead-seat portion, wherein said taper bead-seat portion is substantially contiguous with said rim portion.

20. The method of claim 17, wherein said taper bead-seat is formed with about a 5° taper.

21. The method of claim 18, wherein said wheel is formed with a flat or semi-drop center.

22. The method of claim 14, further comprising the step of forming a center opening in said disc portion.

23. The method of claim 14, further comprising the step of forming at least one mounting opening in said disc portion.

24. The method of claim 14, further comprising the step of forming at least one vent opening in said disc portion.

25. The method of claim 14, further comprising the step of forming at least one valve opening in said disc portion.

26. The method of claim 14, wherein said forming steps comprise at least one of spinning and/or flow forming processes.

27. The method of claim 14, wherein said method utilizes a spinning machine.

28. A steel wheel of unitary construction produced in accordance with the method of claim 14.

29. A method of manufacturing a unitary steel wheel rim and disc assembly for 5° taper bead-seat of flat base or semi-drop center rims of the type having an integral disc and rim portion with gutter, well, 5° bead-seat and fixed flange wherein the said method comprises the following steps
a. Providing a generally circular blank;
b. The blank is preferably of pre-determined uniform thickness
c. The blank is preferably with a center hole pierced to a predetermined size.
d. Preforming the blank to predetermined shape and size, the preform blank is spun and flow formed in a CNC spinning machine, being positioned between a inner mandrel and clamping plate, such mandrel having a outboard surface of predetermined cylindrical shape confirming to predetermined cylindrical shape and profile of the rim gutter, well and fixed flange.
e. The spun and flow formed preform to an predetermined cylindrical shape and size is further spun in a CNC spinning machine to reduce thickness consequently to increase the width in the forward direction to an predetermined size while maintaining the predetermined inner diameter wherein the well, bead seat and the fixed flange are formed in the subsequent operations and at the same time further spinning is preformed on the peripheral portion of the cylinder to displace the preform cylindrical peripheral portion in the backward direction, against the outboard surface of the inner mandrel and outboard surface of the outer ring to a predetermined profile and form of well, bead-seat, fixed flange and the final profile and shape of the gutter wall respectively.
f. The spun preform comprising of finished gutter profile, and cylindrical portion comprising of predetermined shape of the well, bead seat and fixed flange is further spun and flow formed in a spinning machine, the perform being positioned between an outer mandrel and an inner clamping plate, such outer mandrel comprise of a inboard surface which conforms to the final shape of the fixed flange and 5° angle bead-seat, is spun and flow formed against the inner surface of the outer mandrel by a shaping roller of predetermined shape to form the final shape of the fixed flange and 5° bead seat.

30. The method as claimed in claim 27 wherein spin forming the peripheral and inner portion of the blank by engaging the same with a forming roller so as to obtain controlled thickness reduction and shape in the peripheral and inner portion of the blank.

31. The method as claimed in claim 27 wherein the material is displaced in the backward direction during spinning a portion of the perform peripheral cylindrical portion against the outboard surface of an outwardly positioned roll to form the final shape of the rim gutter.

32. The method as claimed in claim 27 wherein spin forming an section of the blank peripheral portion by engaging the same with a forming roller to form the final shape of the well base shape and dimension and at least a portion of the bead seat.

33. The method as claimed in claim 27 wherein spin forming the bead seat portion of the blank outboard section against the shaping surface of the outer mandrel to form the final shape of bead seat and fixed flange.

34. The method as claimed in claim 27, wherein: said first-named spin forming step consists a plurality of passes of the forming roller.

35. The method as claimed in claim 27 wherein after first step of spinning operation bolt holes are pierced in a conventional press.

36. The method as claimed in claim 27 wherein after piercing the bolt holes, vent holes are pierced in a conventional press

37. The method as claimed in claim 27 wherein said step (a) consists the step of providing a disc blank of substantially uniform thickness of low carbon steel or HSLA steel composition.

38. The method as claimed in claim 27 wherein a butt-welded hoop of predetermined diameter, width and thickness can also be used instead of a blank.

39. The method as claimed in claim 36 wherein the butt-welded hoop of predetermined diameter, width and thickness can also be used to manufacture the rim part alone.

40. Apparatus for manufacturing a integral steel wheel rim and disc assembly for 5° taper bead-seat of flat base or semi-drop center rims of the type having an integral disc and rim portion with gutter, well-base, bead-seat and fixed flange wherein the said method comprises means for providing a generally circular blank means for forming the blank to of pre-determined uniform thickness the blank is preferably with a center hole pierced to a predetermined size, the blank is pre-formed in a conventional press, the pre-form blank further spun in a spinning machine, being positioned between an mandrel having a surface which conforms to the final shape of the rim gutter, well, fixed flange and the clamping plate, the blank peripheral and inner portions is spun and flow formed against the surface of the inner or outer mandrel to form the final shapes of the rim gutter, well and the inboard bead seat and flange.

41. Apparatus for manufacturing a integral steel wheel rim and disc assembly for 5° taper bead-seat of flat base or semi-drop center rims for a vehicle having an integral disc and rim portion with gutter, well base, bead-seat and fixed flange manufactured by the process claimed in claim 1.

42. A integral steel wheel rim and disc assembly for 5° taper bead-seat of flat base or semi-drop center rims for a vehicle having an integral disc and rim portion with gutter, well-base, bead-seat and fixed flange wherein when spin forming machine is programmed to form different shapes.

43. A method of manufacturing a integral steel wheel rim and disc assembly for 5° taper bead-seat of flat base or semi-drop center rims for a vehicle having an integral disc and rim portion with gutter, well-base, bead-seat and fixed flange as described in the description of complete specification and as illustrated by way of drawings accompanying the complete specification.

44. A integral steel wheel rim and disc assembly for 5° taper bead-seat of flat base or semi-drop center rims for a vehicle having an integral disc and rim portion with gutter, well-base, bead-seat and fixed flange as described in the description of complete specification and as illustrated by way of drawings accompanying the complete specification.

45. An apparatus for manufacturing from a steel blank a steel wheel of substantially unitary construction comprising a disc portion and a rim portion, said apparatus comprising:
a. a frame;
b. a rotating component which is substantially rotatably affixed to said frame and which rotates said blank;
c. a clamping component which maintains said steel blank in a substantially fixed position relative to said rotating component; and
d. a forming component, wherein said forming component substantially forms said disc and rim portions into said steel wheel of unitary construction from said steel blank.

46. The apparatus of claim 45, wherein, said forming component forms a well into said rim portion of said unitary wheel.

47. The apparatus of claim 45, wherein, said forming component forms a gutter into said rim portion of said unitary wheel.

48. The apparatus of claim 45, wherein, said forming component forms a tire bead seat into said rim portion of said unitary wheel.

49. The apparatus of claim 48, wherein, said forming component forms a tire seat bead having approximately a 5° angle.

50. The apparatus of claim 45, wherein, said forming component forms a flange into said rim portion of said unitary wheel.

51. The apparatus of claim 45, wherein, said forming component forms a unitary wheel having a flat or semi-drop center rim.
